(19) United States
(12) Patent Application Publication
(10) Pub. No.: US 2012/0144127 A1
(43) Pub. Date: Jun. 7, 2012

(54) DATA TRANSMISSION

(75) Inventor: Matthew Morris, Malmesbury (GB)

(73) Assignee: ICERA INC., Wilmington, DE (US)

(21) Appl. No.: 13/378,906

(22) PCT Filed: Jun. 14, 2010
(86) PCT No.: PCT/EP2010/058315

§ 371 Date: Feb. 21, 2012

(30) Foreign Application Priority Data
Jun. 16, 2009 (GB) 0910388.8

(51) Int. Cl. G06F 12/00

(52) U.S. Cl. 711/148; 711/E12.001

(57) ABSTRACT

A method of transmitting data from a first module to addressable storage devices in a second module. The method comprises: transmitting from the first module to a second module in a first transmission cycle an address identifying a storage device in the second module for a data item; at the second module, determining the status of a storage location in the device identified by the address for holding a data item and dispatching in a second transmission cycle a pre-emptive acknowledgement signal, the state of which depends on the status of that storage location; transmitting in the second transmission cycle the data item from the first module to the second module; transmitting the address in a later transmission cycle from the first module to the second module; and selectively transmitting one of the data item and a next data item depending on the state of the pre-emptive acknowledgement signal.

### FIELD OF THE INVENTION

The present invention relates to transmitting data, and in particular to transmitting data in a device comprising a first integrated circuit which is connected to a second integrated circuit via an interface.

### BACKGROUND OF THE INVENTION

The present invention particularly but not exclusively relates to a wireless communications device wherein the first integrated circuit comprises a digital baseband chip and the second integrated circuit comprises an analogue baseband chip.

Such a device is known where the first integrated circuit has a processor which is responsible for the processing functions of the device. This includes signal processing of digital samples received from wireless signals which are received and transmitted by the analogue baseband chip. Digital samples from wireless signals received by the analogue baseband chip are transferred to the digital baseband chip over a parallel interface.

Digital data to be transmitted in the form of a wireless signal (radio data) is transmitted from the digital baseband chip to the analogue baseband chip over the interface.

Digital data is passed between the digital baseband chip and the analogue baseband chip under the control of the digital baseband chip. The processor controls the interface in slots and is programmed to move data from a storage location in one chip to a storage location in another chip. The storage locations can be FIFOs. Each slot can be programmed with the following information:
(i) the address of a storage location (FIFO ID) to select the storage location on the digital chip from which to retrieve data; and
(ii) an address of a storage location on the analogue baseband chip to emit on the interface.

Data transmission is under the control of a clock signal.

Each time a particular slot N comes around, the digital baseband chip emits, in that clock cycle, an address in the analogue baseband chip programmed against slot N onto the interface and in the next cycle (or a predetermined number of cycles thereafter) the digital baseband chip either emits data onto the interface from the FIFO associated with the slot N, or the analogue baseband chip will transmit data onto the interface, depending on the direction of the transfer. When the digital baseband chip emits data onto the interface, it is stored in the analogue baseband chip at the address which was programmed against that slot N.

For each slot, the analogue baseband chip passes back an acknowledgement signal (ACK) in the same cycle as the data is transferred. To be more precise, in the cycle immediately after the cycle transferring the address, which is the same as the cycle in which the data is transferred. The ACK advises the digital baseband chip that data transmitted from the digital baseband chip to the analogue baseband chip has been accepted, that is that there was room to store data at the location using the address programmed against slot N, or that data received from the analogue baseband chip is valid and has not been taken from an empty location.

Due to synchronisation issues over the interface, the acknowledgement signal ACK can be received a number of cycles after the cycle in which the data was transferred. This can cause difficulties when data is being emitted from the digital baseband chip to the analogue baseband chip. Data from the digital baseband chip is emitted from FIFOs, each FIFO operating such that once a data item has been emitted, the FIFO has an access pointer (or read pointer) which sets to the next data item in the FIFO. The next time that FIFO is addressed, it will expect to send the next data item. However, it can only do this if it is sure that the first data item has been correctly acknowledged. Therefore, where the return of acknowledgements are delayed by several cycles, it is not possible to implement back-to-back accesses to any particular FIFO. Instead, there must be a number of cycles between accesses to the same FIFO to accommodate the fact that the return acknowledgement ACK may be delayed.

It will be appreciated that this can cause a problem of unnecessary delays and programming complexity because in principle the processor can control a sequence of slots to access the same transmit FIFO on the digital chip. However, this cannot be handled with the above acknowledgement scheme.

### SUMMARY OF THE INVENTION

According to an aspect of the present invention there is provided a method of transmitting data from a first module to addressable storage devices in a second module, each storage device having a plurality of storage locations, the method comprising: transmitting from the first module to a second module in a first transmission cycle an address identifying a storage device in the second module for a data item; at the second module, determining the status of a storage location in the device identified by the address for holding a data item and dispatching in a second transmission cycle a pre-emptive acknowledgement signal, the state of which depends on the status of that storage location; transmitting in the second transmission cycle the data item from the first module to the second module; transmitting said address in a later transmission cycle from the first module to the second module; and selectively transmitting one of the data item and a next data item depending on the state of the pre-emptive acknowledgement signal.

Another aspect of the invention provides A transmission module comprising: a plurality of storage devices holding data items for transmission; a controller operable to issue in a first transmission cycle an address identifying a storage device in a second module for a data item; means operable to transmit in a second transmission cycle a data item from the first module to the second module; means operable to determine the state of a pre-emptive acknowledgement signal, the state of which depends on the status of a storage location in the second module for holding the data item; the controller operable to transmit said address in a later transmission cycle from the first module to the second module; and logic circuitry arranged to selectively transmit one of the data item and a next data item depending on the state of the pre-emptive acknowledgement signal.

A further aspect of the invention provides a receiver module comprising: a plurality of addressable storage devices, each storage device having a plurality of storage locations; and means operable to receive an address identifying one of the addressable storage devices and to determine the status of a next available storage location in the device identified by the address and dispatching a pre-emptive acknowledgement signal, the state of which depends on the status of that storage location.

The invention further provides a communication system comprising a transmitter module and a receiver module as hereinabove defined.

In a back-to-back mode, the later transmission cycle is the next cycle after the second transmission cycle. The data item and the next data item can be supplied from a storage device on the first module in the same timing cycle. The data item can be stored in a first storage element and the next data item in a second storage element. Switching circuitry can be provided for selectively transmitting from the first or second storage element in dependence on the state of the pre-emptive acknowledgement signal.

The pre-emptive acknowledgement signal can be retimed at the first module. This allows the timing of the acknowledgement signal to match the timing of transmission of the data item.

In an alternative mode, prior to the step of transmitting said address in the later transmission cycle, a different address is transmitted followed by a data item for storing at said different address. In this case, storing the pre-emptive acknowledgement signal at the first module in association with the first mentioned address allows it to be used when the address is transmitted again to determine whether the data item or next data item should be transmitted.

For a better understanding of the present invention and to show how the same may be carried into effect, reference will now be made by way of example to the accompanying drawings, in which:

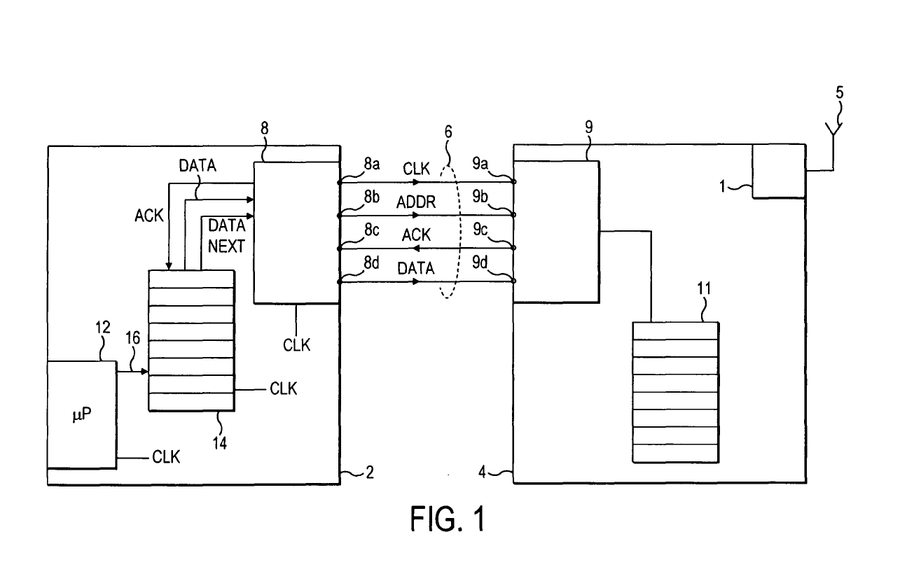

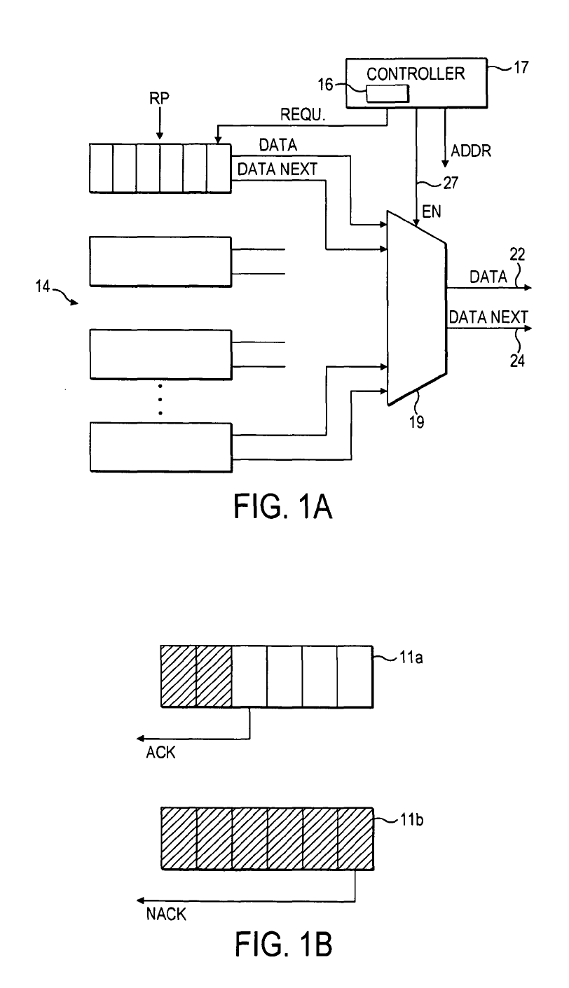

FIG. 1 is a schematic block diagram of a wireless communications device;

FIG. 1A is a schematic diagram of slot control;

FIG. 1B illustrates full and empty storage devices;

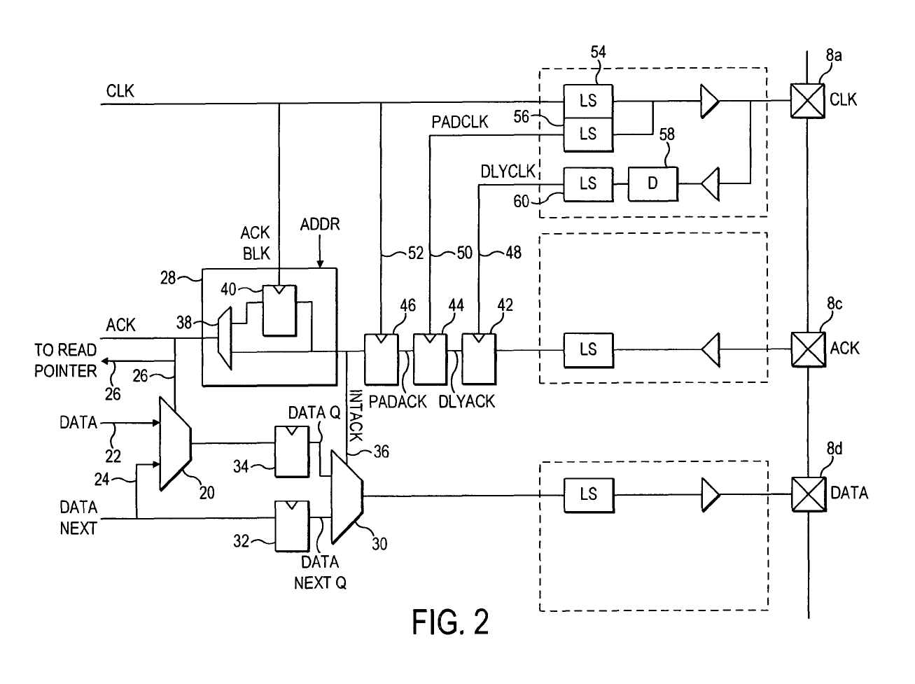

FIG. 2 is a circuit diagram of logic for implementing an embodiment of the invention; and

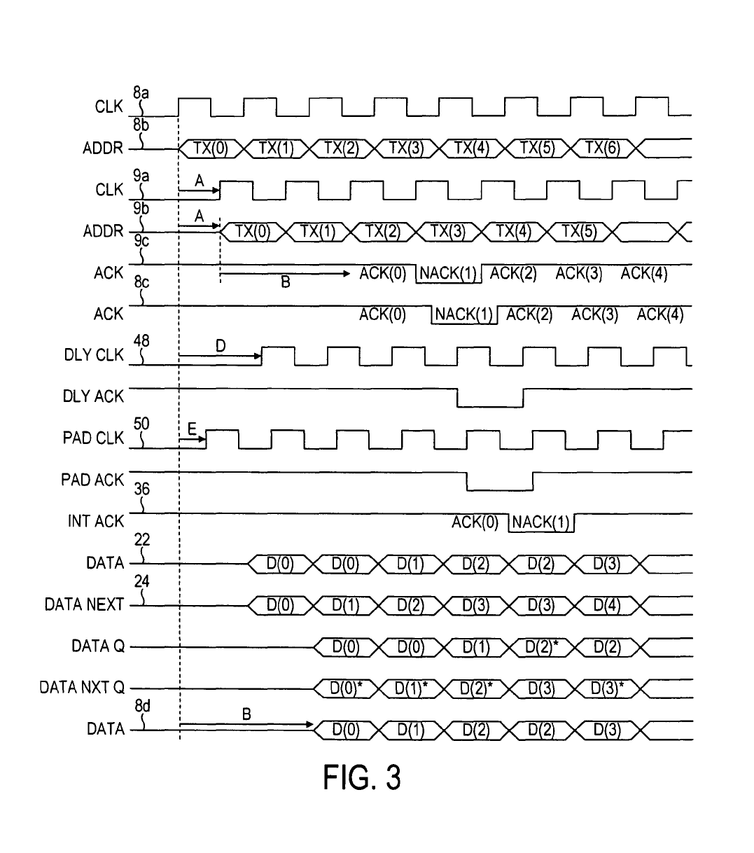

FIG. 3 is a timing diagram.

FIG. 1 is a schematic block diagram of a wireless communications device comprising a digital baseband chip 2 and an analogue baseband chip 4. The analogue baseband chip 4 is associated with an RF transceiver device 1 connected to an antenna 5. The RF receiver device 1 and the antenna 5 could constitute a separate module to the analogue baseband chip 4, or be part of the same module.

The analogue baseband chip 4 includes analogue-to-digital converters (ADC) and digital-to-analogue converters (DAC) which are used to convert signals between the digital format provided by the digital baseband chip 2 and the analogue format required by the RF transceiver device 1. The data which is converted to or from radio frequencies in the RF transceiver device 1 and sent or received over the RF antenna 5 is referred to as radio data. This data is supplied in digital form from the digital baseband chip 2 via a parallel interface 6.

The digital baseband chip 2 comprises a microprocessor 12 which is responsible for the processing functions of the devices. This includes signal processing of digital samples received from the wireless signals, generation of digital samples to be converted and transmitted to the analogue baseband chip and general operational and housekeeping functions. The microprocessor 12 communicates with a block of storage devices in the form of FIFOs 14. The microprocessor controls the interface in slots. Each slot can be programmed with the following information:
(i) the address of a storage device (FIFO ID) to select the storage location on the digital chip from which to retrieve data; and
(ii) an address of a storage device on the analogue baseband chip to emit on the interface.

A slot pointer 16 points to the current FIFO of interest. This is shown diagrammatically only—it will be appreciated that any suitable software, firmware or hardware implementation could be utilised. The FIFOs 14 are connected to an interface manager 8. As discussed in more detail hereinafter, when back-to-back mode is enabled each FIFO 14 supplies a DATA and a DATA NEXT signal to the interface manager 8, and receives an acknowledgement signal ACK/NACK from the interface 6. The DATA signal is read from the location pointed to by a read pointer RP; DATA NEXT is read from the next location. Once read, RP is incremented. For each slot an address ADDR is passed to the interface manager 8. The interface manager contains a controller 17 (FIG. 1A) to control which slot is active. The interface manager 8 has connectors connecting to wires of the interface 6. Connector 8a supplies an interface clock CLK, connector 8b supplies the address ADDR (4 bits wide in the embodiment), connector 8c receives the acknowledgement ACK/NACK (1 bit) and connector 8d supplies a 16-bit data word DATA in each cycle. The wires are connected to a corresponding interface manager 9 on the analogue baseband chip 4. The interface manager 9 is connected to a set of storage devices in the form of FIFOs 11. These storage devices are addressed by addresses received over the wires ADDR from the digital baseband chip. In the embodiment they are FIFOs, but they could be registers or other types of memory where each address identifies a device with multiple storage locations. The interface manager 9 has connectors 9a to 9d corresponding to connectors 8a to 8d for receiving the corresponding signals. It will be appreciated that there is a delay over the link such that the edge of a signal emitted at connector 8a will be received at its corresponding connector 9a some time later.

FIG. 1A shows the relationship between the controller 17 and FIFOs 14 in more detail. The slot pointer 16 issues a request REQU to the FIFO 14 associated with the slot N identified by the slot pointer 16. In FIG. 1A, a wire for this signal is shown only going into the first FIFO but it will be appreciated that an equivalent wire runs into each of the FIFOs 14 shown in FIG. 1A. Each FIFO has a plurality of storage locations which store data items and is capable of outputting simultaneously a first data item DATA and a next data item DATA NEXT. The DATA and DATA NEXT outputs from each FIFO are supplied to a multiplexer 19 which is controlled by an enable signal EN. The multiplexer 19 outputs a first data item DATA on line 22 and a next data item DATA NEXT on line 24 when the enable signal EN is active. The ENABLE signal 27 is active where there are back-to-back accesses from the same FIFO.

The controller 17 also issues the address ADDR of the storage device on the analogue baseband chip where the data item is to be stored. The address signal ADDR is transmitted over connector 8b as described earlier, and is also supplied to a logic circuit on the digital baseband chip as described more fully hereinafter.

FIG. 1B is a schematic diagram which shows the storage devices 11 located on the analogue baseband chip. Each storage device is shown as having six storage locations, wherein a shaded storage location implies that it holds data and an unshaded location implies that it is available to hold data. It will be appreciated that any number of storage locations per storage device is possible.

The storage device 11a is shown having two locations holding data items and four available storage locations. The storage device 11b is shown as having no available storage locations. When the address of the storage device 11a is received by the analogue baseband chip, a pre-emptive acknowledgement signal ACK is returned from the analogue baseband chip to the digital baseband chip, the status ACK indicating that the storage device 11a has a storage location available for a subsequent data item.

Conversely, when the address of storage device 11b is received at the analogue baseband chip, a pre-emptive acknowledgement signal NACK is returned, NACK denoting a status indicating that the storage device has no available storage locations for subsequent data items.

It will be appreciated more fully from the following that the ACK status can be returned if there is at least one storage location available to receive a data item. It is possible however based on timing issues as discussed more fully in the following to restrict the ACK status to a situation where there are at least two storage locations available to receive data items. Similarly, the NACK status can be returned when there are no available storage locations or only one storage location is available.

It is important to note that these acknowledgement signals are pre-emptive in the sense that they are not acknowledging the successful storage of the last received data item, but are indicating whether there is a storage location available for a subsequent data item to be stored.

The interface manager 8 includes a logic circuit as illustrated in FIG. 2. The DATA and DATA NEXT signals from the selected FIFO 14 are supplied to a MUX along lines 22, 24 respectively. The MUX is controlled by the acknowledgement signal ACK on line 26, received from an acknowledgement block 28. The acknowledgement signal 26 feeds back to the selected FIFO to increment the read pointer.

The logic circuit also includes a retimed acknowledgement control mechanism for use in back-to-back mode. This includes a latch 32 for holding the DATA NEXT signal and a latch 34 for holding the output of the first multiplexer 20. A second multiplexer 30 receives inputs from the latches 32, 34 and is controlled by an internal signal INT ACK 36, which is generated from receipt of the acknowledgement signal returning from the analogue baseband chip, in a manner which will be described more clearly hereinafter. The INT ACK signal 36 is supplied as an input to the acknowledgement block 28. Acknowledgement block 28 is an important component of the logic circuit when different FIFOs are addressed in sequence. It holds in association with each issued address ADDR a pre-emptive acknowledgement signal returned from the analogue baseband chip and retimed. It will be appreciated that retiming of the acknowledgement signal is not an essential feature of the invention, but can be useful in some circumstances where the internal acknowledgement INT ACK is used as described later. The acknowledgement block 28 is shown comprising a latch 40 which can hold the ACK/NACK bit for one address. Although not shown, it will be appreciated that there are multiple latches for multiple acknowledgement signals associated with multiple addresses. A multiplexer 38 allows selection either of the prestored acknowledgement signal or the incoming acknowledgement signal depending on the mode of operation of the circuit.

Before describing the INT ACK signal in more detail, the basic mechanisms will be described.

The following describes a mechanism for allowing back-to-back access to FIFOs on the chip 2.

For each RP position, a subsequent item of data (DATA NEXT) is taken from a selected FIFO as well as a current item of data being accessed (DATA). This saves a clock cycle as DATA NEXT can replace DATA after the latches 32, 34 to the output.

Additionally, on chip 4, the acknowledgement ACK is generated on a look ahead basis, when a FIFO is addressed. That is, if an addressed FIFO in the analogue baseband chip 4 has spaces left, the ACK signal is high, but if there is no space left, the ACK signal is low (NACK).

When the same FIFO 11 is next addressed, if the ACK signal is high this implies that the data item which was transmitted after the last time the FIFO was addressed has been properly stored, and therefore on this occasion DATA NEXT can be selected for transmission. If however the status of the ACK signal is low (NACK), this implies that the data item which was sent after the FIFO was last addressed will not have been properly stored and may have been lost. In that case, the data item DATA is resent.

One mechanism uses the storing of a pre-emptive acknowledgement to save cycles over the interface, where subsequent reads are to different FIFOs.

For back-to-back operation where the same FIFO 14 is being selected for subsequent reads, the internal acknowledgement signal INT ACK associated with the intended address.

The INT ACK signal 36 is generated from an incoming acknowledgement signal at connector 8c via three latches 42, 44, 46. These latches are timed by respective timing signals 48, 50, 52, generated by the clock signal CLK, as follows.

A first timing signal 52 is derived directly from the clock signal CLK. A second timing signal 50 is delayed by amount E with respect to the clock CLK by virtue of interposition of two level shifters 54, 56. A third timing signal 48 is generated from the clock CLK but delayed by an amount D by a delay element 58 and a further level shifter 60. The second timing signal 50 that controls the latch 44 is termed herein PAD CLK. The third timing signal 48 that controls the latch 42 is referred to herein as DLYCLK.

Operation of the back-to-back mechanism will now be described with reference to FIGS. 1 and 2 and the timing diagram of FIG. 3. On the rising edge of each clock signal CLK at the connector 8a, an address TX(0) of a storage location on chip 4 is emitted at connector 8b. A data item D(0) follows in the next cycle.

The clock and address signals are received at the connectors 9a, 9b of chip 4 after a delay A which represents the delay in the direction from chip 2 to chip 4, including the block to connector delay, level shifter delay and interchip delay. In the next cycle, a subsequent address TX(1) is transmitted. A subsequent data item D(1) follows in the next cycle. An acknowledgement signal ACK(0) is issued relating to address TX(0). Thus, there is a two cycle delay from receipt of the first address and issuance of the first acknowledgement. The acknowledgement ACK(0) is in respect of the storage location at the device addressed by address TX(0) for a subsequent data item (d(1)), so-called “look-ahead”. The look ahead is based upon the FIFO ID in the analogue chip, so ACK(0) also refers to TX(1) if TX(0) and TX(1) are the same address. Registers 40 in the acknowledgement block 28 in FIG. 2 hold the last recorded ACK for a particular address n.

The next acknowledgement which is sent NACK(1) has a changed logical state from ACK(0) indicating that the FIFO, when addressed again is not ready to accept data. In this case it will not accept the next data item D(2). In the timing diagram it is assumed that TX(0) . . . TX(5) are all accessing the same digital FIFO (on the transmit side) and the same analogue chip FIFO on the receive side. This is important as the ACK for a data item in one FIFO, e.g. 11a, does not affect which data is sent when pulling from another FIFO, 11b. If FIFO A is read in cycle X, the ACK will be resolved and the read pointer updated in the FIFO in cycle X+3.

The acknowledgements are received at connector 8c of chip 2 after a respective delay C which represents the interchip delay in the direction of chip 4 to chip 2.

The signal DLYCLK 48 retimes the acknowledgement signal by interposing a delay D (58). Delay D is the round trip delay from interface to connector logic, outgoing level shifter, and interchip time to chip 4 (which launches the DATA/ACK back to chip 2), plus the delay in data/ack from chip 4 to chip 2 and the delay through the level shifter and back to interface. The signal PADCLK 50 further retimes the acknowledgement signal by an amount E referenced to the clock signal CLK. This results in a retimed internal acknowledgement signal INT ACK 36 which controls the multiplexer 30. If the acknowledgement signal is positive, DATA NEXT is sent. However, when the acknowledgement signal is negative (as in the case of NACK(1)) the data input switches over to DATA and the FIFO access pointer is not updated resulting in a resend of the data item. In a situation where the acknowledgement signal doesn't need to change between FIFOs from which the data is read, then DATA and DATA NEXT will be driven with the same value so that state of the acknowledgement signal is immaterial.

The DATA and DATA NEXT lines 22, 24 show the data items pulled from the FIFO. Note that for the first data item D(0), the same data item is supplied on DATA NEXT. This is to ensure that when there has been a change in FIFO identifier between accesses, data is not forwarded incorrectly when accessing a new FIFO. That is, although the mechanism is set up to facilitate sequential accesses from the same FIFO, it has to take into account the fact that there may be a change of identifier of FIFOs between accesses. DATA and DATA NEXT are both D(0) because there is no recent history of the chip 2 FIFO being used in the last three cycles. ACK will have resolved the FIFO pointer so the DATA sent for this request is known and ACK cannot affect the data item sent, therefore DATA=DATA NEXT will always result in DATA on the connectors: MUX 30 can only choose between DATA and DATA NEXT.

On subsequent accessing cycles however, the DATA line carries the current item of data, while the DATA NEXT line carries the subsequent item of data. Note that on the INT ACK signal, the DATA D(2) and DATA NEXT D(3) are reset onto the inputs of the MUX 20.

The line DATA Q shows the data items at the output of the multiplexer 20, shifted by one cycle as a result of the latch 34 (i.e. at input of MUX 30).

The line DATA NEXT Q shows the data items on the DATA NEXT line, shifted by one cycle as a result of latch 32 (i.e. at input of MUX 30).

Note the data items on the data line 22. It is assumed that data item D0 is stored properly. The signal ACK(0) indicates that D(1) will have been stored properly. However, data item D(2) is the one destined for the transmission TX(2). This location has been identified on a look-ahead basis as being unable to accept data—see NACK(1). This is fed back to the read pointer of the FIFO so it remains in its current position (D(2)). On the next cycle the multiplexer 20 propagates DATA, resulting in data item D(2) being transferred to latch 34 (the FIFO access pointer is still at D(2)).

The MUX 30 acts to switch between DATA Q and DATA NEXT Q based on the retimed acknowledgement signal INT ACK. When INT ACK is positive, the MUX 30 passes DATANEXT Q. When INT ACK is negative, it switches from DATA NEXT Q to DATA Q. This permits the data transmitted at connector 8d to carry the data item D2 twice in successive clock cycles. The asterisk in FIG. 3 on the data items for the signals DATA Q and DATA NEXT Q denote the item which is selected by the INT ACK signal 36 to be transmitted at the data connector 8d.

1. A method of transmitting data from a first module to addressable storage devices in a second module, each storage device having a plurality of storage locations, the method comprising:
transmitting from the first module to a second module in a first transmission cycle an address identifying a storage device in the second module for a data item;
at the second module, determining the status of a storage location in the device identified by the address for holding a data item and dispatching in a second transmission cycle a pre-emptive acknowledgement signal, the state of which depends on the status of that storage location;
transmitting in the second transmission cycle the data item from the first module to the second module;
transmitting said address in a later transmission cycle from the first module to the second module; and
selectively transmitting one of the data item and a next data item depending on the state of the pre-emptive acknowledgement signal.

2. A method according to claim 1, comprising storing the pre-emptive acknowledgement signal at the first module in association with said address.

3. A method according to claim 2, wherein prior to the step of transmitting said address in a later transmission cycle, a different address is transmitted followed by a data item for storing at said different address.

4. A method according to claim 1, wherein the later transmission cycle is the next cycle after the second transmission cycle in a back-to-back mode.

5. A method according to claim 4, comprising the step of retiming the pre-emptive acknowledgement signal at the first module.

6. A method according to claim 4, wherein the data item and the next data item are supplied from a storage device on the first module in the same timing cycle.

7. A method according to claim 6, comprising the step of storing the data item in a first storage element, and storing the next data item in a second storage element and selectively transmitting from the first or second storage element in dependence on the state of the pre-emptive acknowledgement signal.

8. A method according to claim 1, comprising the step of issuing said address for transmission responsive to a timing signal.

9. A method according to claim 8, wherein said timing signal is transmitted from the first module to the second module for controlling dispatch of the acknowledgement signal.

10. A transmission module comprising:
a plurality of storage devices holding data items for transmission;
a controller operable to issue in a first transmission cycle an address identifying a storage device in a second module for a data item;
means operable to transmit in a second transmission cycle a data item from the first module to the second module;
means operable to determine the state of a pre-emptive acknowledgement signal, the state of which depends on the status of a storage location in the second module for holding the data item;
the controller operable to transmit said address in a later transmission cycle from the first module to the second module; and
logic circuitry arranged to selectively transmit one of the data item and a next data item depending on the state of the pre-emptive acknowledgement signal.

11. A transmission module according to claim 10, comprising means for storing the pre-emptive acknowledgement signal in association with said address.

12. A transmission module according to claim 10, wherein the storage devices are operable in a back-to-back mode to supply the data item and the next data item in the same timing cycle to the logic circuitry.

13. A transmission module according to claim 10, comprising means for retiming the pre-emptive acknowledgement signal.

14. A transmission module according to claim 10, comprising a digital baseband chip.

15. A transmission module according to claim 10, comprising a first storage element for holding the data item and a second storage element for holding the next data item and further comprising switching circuitry for selectively transmitting from the first or second storage element in dependence on the state of the pre-emptive acknowledgement signal.

16. A receiver module comprising:
a plurality of addressable storage devices, each storage device having a plurality of storage locations; and
means operable to receive an address identifying one of the addressable storage devices and to determine the status of a next available storage location in the device identified by the address and dispatching a pre-emptive acknowledgement signal, the state of which depends on the status of that storage location.

17. A receiver module according to claim 16, comprising an analogue baseband chip.

18. A communications system comprising a transmitter module according to claim 10 and a receiver module including:
a plurality of addressable storage devices, each storage device having a plurality of storage locations; and
means operable to receive an address identifying one of the addressable storage devices and to determine the status of a next available storage location in the device identified by the address and dispatching a pre-emptive acknowledgement signal, the state of which depends on the status of that storage location.

19. A communications system according to claim 18, wherein the receiver module includes an analogue baseband chip.

20. A method according to claim 7, comprising the step of issuing said address for transmission responsive to a timing signal.
